(19) United States
(12) Patent Application Publication
(10) Pub. No.: US 2005/0236012 A1
(43) Pub. Date: Oct. 27, 2005

(54) Apparatus and method for cleaning surfaces

(76) Inventors: Thomas Josefsson, Bloomington, IL (US); Christer Kontio, Bloomington, IL (US); Arnie Sepke, Hudson, IL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/098,539

(22) Filed: Apr. 5, 2005

Related U.S. Application Data
(60) Provisional application No. 60/559,036, filed on Apr. 5, 2004.

(51) Int. Cl. B08B 3/12; A47L 7/00

(52) U.S. Cl. 134/1; 134/10; 15/320

(57) ABSTRACT

A method for cleaning surfaces having the steps of depositing a cleaning fluid onto the surface from a cleaning fluid reservoir on a wet extractor, contacting the surface with a hand-held ultrasonic spot cleaner, applying ultrasonic vibrations to the surface using the hand-held ultrasonic spot cleaner to help release soil form the surface, and removing the cleaning fluid and soil using the wet extractor. A wet extractor having an ultrasonic cleaning component is also provided. Further provided is a combined cleaning system having a cleaning device and a hand-held ultrasonic spot cleaner. The cleaning device has a dirt receptacle, a nozzle adapted to be positioned adjacent a surface to be cleaned, and a vacuum source adapted to generate a working air flow from the nozzle to the dirt receptacle. The hand-held ultrasonic spot cleaner includes an ultrasonic wave generating source, an ultrasonic cleaning head adapted to be driven by the ultrasonic wave generating source, and a control switch adapted to selectively activate the ultrasonic wave generating source. Multiple variations thereof are also provided.

### FIELD OF THE INVENTION

The present invention relates generally to cleaning systems, and more specifically to devices and methods for cleaning floors, fabrics, carpets, clothing, upholstery, curtains, fabric, floors and various other hard and soft surfaces.

### BACKGROUND OF THE INVENTION

Many cleaning systems have been proposed for caring for carpeted and bare floors and various fabrics, such as clothing, upholstery and curtains. Examples of conventional cleaning systems include simple scrubbing tools, such as sponges and mops, and more complex vacuum devices, wet extraction devices (vacuums used in conjunction with a deposited fluid), steam cleaners (which use steam or hot water), and ultrasonic cleaning devices. Such devices are often used in conjunction with water, detergents and other chemicals that are useful in removing dirt, bacteria, stains or other undesired contaminants from the surface being cleaned.

Although the known cleaning devices have been useful for performing particular cleaning operations, various shortcomings continue to affect the performance of these devices. For example, while wet extractors have been found to be useful for removing embedded dirt and stains, such devices are sometimes unable to restore carpets to their “as new” condition. In other cases, wet extractors are generally adequate at refurbishing the carpet, but are still unable to remove localized dirt concentrations or stains. As such, there remains a need to provide wet extractors and other types of cleaners that are better able to remove stubborn localized or widespread stains and dirt concentrations.

### SUMMARY OF THE INVENTION

In one embodiment, the invention provides a method for cleaning surfaces. The method includes the steps of depositing a cleaning fluid onto the surface from a cleaning fluid reservoir on a wet extractor, contacting the surface with a hand-held ultrasonic spot cleaner, applying ultrasonic vibrations to the surface using the hand-held ultrasonic spot cleaner to help release soil from the surface being cleaned, and removing the cleaning fluid and soil from the surface using the wet extractor. The method may also have variations that involve steps of: agitating the surface with a mechanical agitator on the wet extractor; depositing a rinsing fluid onto the surface from a rinsing fluid reservoir on the wet extractor and removing the rinsing fluid from the surface using the wet extractor; depositing a second fluid onto the surface from a second fluid reservoir separate from the wet extractor and the hand-held ultrasonic spot cleaner; and depositing a second fluid onto the surface from a second fluid reservoir on the hand-held ultrasonic spot cleaner.

In another embodiment, the invention provides an ultrasonic wet extractor having a base assembly adapted to be moved on a surface to be cleaned, a handle assembly pivotally connected to the base assembly and adapted to be used to direct the movement of the base assembly, one or more fluid supply tanks, a fluid deposition system adapted to deposit at least a first fluid from the one or more fluid supply tanks onto the surface, a fluid recovery tank, an elongated extraction nozzle mounted on the base assembly and positioned to face the surface, and a vacuum source adapted to create a working air flow from the extraction nozzle to the fluid recovery tank. The device also includes an ultrasonic vibration device, mounted in the base assembly adjacent the surface and adapted to impart ultrasonic vibrations to the surface. In various embodiments, at least one of the one or more fluid supply tanks may be mounted on the base assembly, and may comprise a water supply tank and a detergent tank. The recovery tank may also be mounted on the base assembly. In another variation, the ultrasonic vibration device may include a laterally-extending carrier bar, a plurality of cleaning heads mounted to the carrier bar, and one or more ultrasonic drivers adapted to impart ultrasonic vibrations in the plurality of cleaning heads. The ultrasonic vibration device may also be movable, relative to the base assembly, in a direction perpendicular to the surface.

In a third embodiment, the present invention provides a combined cleaning system having a cleaning device and a hand-held ultrasonic spot cleaner. The cleaning device has a dirt receptacle, a nozzle adapted to be positioned adjacent a surface to be cleaned, and a vacuum source adapted to generate a working air flow from the nozzle to the dirt receptacle. The hand-held ultrasonic spot cleaner includes an ultrasonic wave generating source, an ultrasonic cleaning head adapted to be driven by the ultrasonic wave generating source, and a control switch adapted to selectively activate the ultrasonic wave generating source.

Multiple variations of the embodiments are provided. For example, the combined cleaning system may have a mount to hold the hand-held ultrasonic spot cleaner on the cleaning device, such as a holster on the cleaning device adapted to receive the hand-held ultrasonic spot cleaner. The combined cleaning system may also have an electrical circuit adapted to provide electricity to the hand-held ultrasonic spot cleaner. Such an electrical circuit may be a flexible electrical cord connecting the cleaning device to the hand-held ultrasonic spot cleaner. The flexible electrical cord may be retractable on a cordreel in the cleaning device housing, and may be disconnectable from at least one of the cleaning device and the hand-held ultrasonic spot cleaner. The electrical circuit may also include electrical terminals that attach the cleaning device to the spot cleaner when the spot cleaner is inserted into a holster on the cleaning device.

In other variations, the hand-held ultrasonic spot cleaner may have batteries, which may be rechargeable, or may have an electrical cord that powers the spot cleaner from a wall outlet. If the batteries are rechargeable, the device may have a charging circuit for recharging the batteries. Such a charging circuit may include an electrical circuit that attaches to a corresponding circuit in the cleaning device. The charging circuit may also include a visual indicator that indicates when the batteries are being charged. The charging circuit may also be an electrical cord adapted to engage a wall outlet, and this electrical cord may be selectively detachable from the spot cleaner. The charging circuit also may have electrical prongs that are located on the spot cleaner and adapted to selectively engage a wall outlet. Such electrical prongs may be selectively retractable into the spot cleaner.

In still other variations of the third embodiment, the hand-held ultrasonic spot cleaner may also have an audible signal generator adapted to create a human-audible sound when the ultrasonic wave generating source is activated. The spot cleaner may also have a fluid supply reservoir mounted to it, or such a fluid supply reservoir may be stored on the cleaning device.

In various configurations, the cleaning device may have a base assembly adapted to be moved on a surface to be cleaned and a handle assembly pivotally connected to the base assembly and adapted to be used to direct the movement of the base assembly. The cleaning device may also be a wet extractor having one or more fluid supply tanks and a fluid deposition system adapted to deposit at least a first fluid from the one or more fluid supply tanks onto a surface to be cleaned. In this configuration, the dirt receptacle is a recovery tank and the nozzle is an extraction nozzle. The cleaning device may instead be a vacuum cleaner, in which case the dirt receptacle is a vacuum bag or a dirt cup.

In another embodiment, the present invention provides a combined cleaning system having a wet extractor and a hand-held ultrasonic spot cleaner adapted to be selectively mounted on the wet extractor. The wet extractor includes one or more fluid supply tanks, a fluid deposition system adapted to deposit at least a first fluid from the one or more fluid supply tanks onto a surface to be cleaned, a recovery tank, an extraction nozzle adapted to be positioned adjacent the surface to be cleaned, and a vacuum source adapted to generate a working air flow from the extraction nozzle to the recovery tank. The hand-held ultrasonic spot cleaner includes an ultrasonic wave generating source, an ultrasonic cleaning head adapted to be driven by the ultrasonic wave generating source, and a control switch adapted to selectively activate the ultrasonic wave generating source. The spot cleaner may be selectively electrically attachable to the wet extractor.

In still another embodiment, the present invention provides a combined cleaning system having a vacuum cleaner and a hand-held ultrasonic spot cleaner adapted to be selectively mounted on the vacuum cleaner. The vacuum cleaner has a dirt container, a nozzle adapted to be positioned adjacent the surface to be cleaned, and a vacuum source adapted to generate a working air flow from the nozzle to the dirt container. The hand-held ultrasonic spot cleaner includes an ultrasonic wave generating source, an ultrasonic cleaning head adapted to be driven by the ultrasonic wave generating source, and a control switch adapted to selectively activate the ultrasonic wave generating source. The spot cleaner of this embodiment may be selectively electrically attachable to the vacuum cleaner.

### BRIEF DESCRIPTION OF THE DRAWINGS

FIG. 1 shows a first embodiment of a combined cleaning system of the present invention.

FIG. 2A shows a second embodiment of a combined cleaning system of the present invention.

FIG. 2B is a fragmented view of the holster arrangement and a first embodiment of the ultrasonic spot cleaner of the embodiment of FIG. 2A.

FIG. 2C shows an alternative embodiment of the ultrasonic spot cleaner of the embodiment of FIG. 2A.

FIG. 2D shows another alternative embodiment of the ultrasonic spot cleaner of the embodiment of FIG. 2A.

FIG. 3A shows a third embodiment of a combined cleaning system of the present invention.

FIG. 3B shows a fragmented view of the holster and ultrasonic spot cleaner of the embodiment of FIG. 3A.

FIG. 4A shows a fourth embodiment of a combined cleaning system of the present invention.

FIG. 4B is a fragmented view of the holster and ultrasonic spot cleaner of the embodiment of FIG. 4A.

FIG. 5A shows a fifth embodiment of a combined cleaning system of the present invention.

FIG. 5B is a partially cutaway view of the circled portion of the embodiment of FIG. 5A.

FIG. 5C is a partially exploded view of the circled portion of the embodiment of FIG. 5A.

FIG. 6A is a cutaway front view of a sixth embodiment of a combined cleaning system of the present invention.

FIG. 6B is a cutaway side view of the embodiment of FIG. 6A.

FIG. 7A is a front view of a seventh embodiment of a combined cleaning system of the present invention.

FIG. 7B is a partially cutaway side view of the embodiment of FIG. 7A.

FIG. 8 shows still another embodiment of a combined cleaning system of the present invention.

### DETAILED DESCRIPTION OF THE PREFERRED EMBODIMENTS

The present invention generally provides a combined cleaning device having a wet extractor cleaning component and an ultrasonic cleaning component. Alternatively, it is also preferred to replace the wet extractor component with a dry vacuum component, steam cleaner component, or other type of cleaning device. In various embodiments, the cleaning components can be separate, or permanently or removably attached to one another.

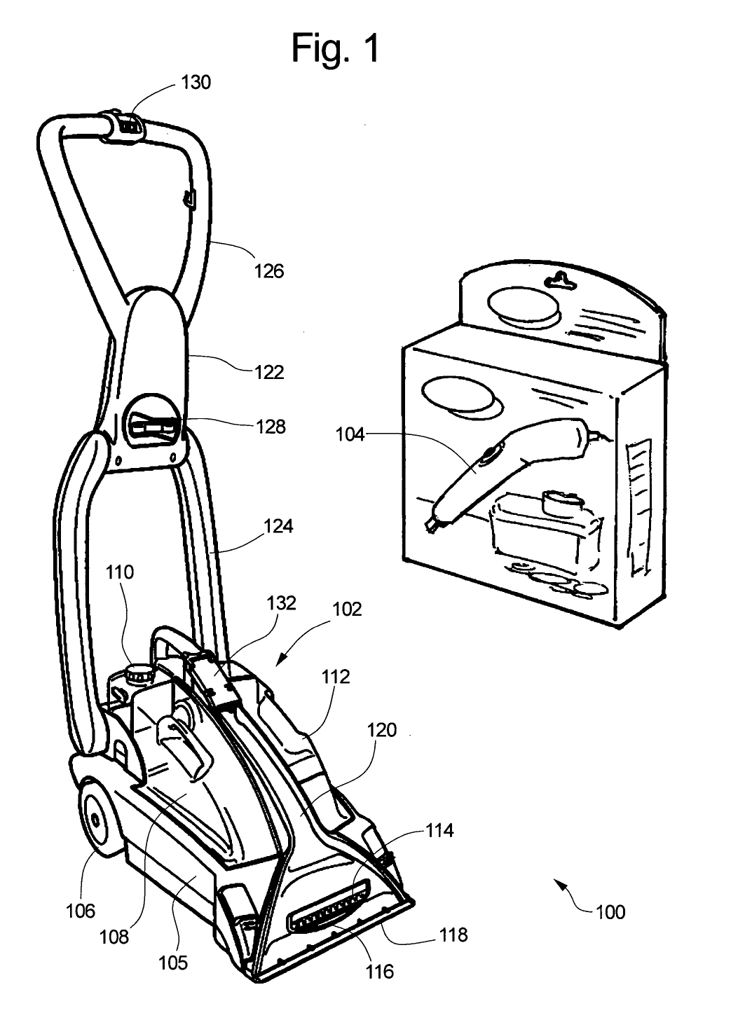

Referring now to FIG. 1, a first embodiment of the invention is shown. In this embodiment, the combined cleaning device 100 includes a wet extractor 102 and an ultrasonic spot cleaner 104 (shown packaged and not to scale). The wet extractor 102 preferably comprises an upright, canister, or portable style wet extractor unit that applies a fluid to a surface to be cleaned, then recovers the fluid using a suction device. The wet extractor 102 may be corded to operate from a wall outlet, or may be battery operated. Exemplary wet extractors are described in U.S. Pat. Nos. 3,355,762; 5,075,920; 5,400,462; 5,933,912; 6,189,174; 6,286,180; 6,325,864, all of which are incorporated herein by reference.

The wet extractor 102 can comprise and operate like any wet extractor. For example, in the embodiment of FIG. 1, the wet extractor 102 comprises a base portion 105 that is adapted to move across a floor surface, preferably by the provision of wheels 106. The base 105 has a vacuum source (not shown) and appropriate motor (not shown) housed therein. The base 105 also includes a water supply tank 108, a detergent tank 110, and a recovery tank 112. Water and detergent are supplied from their respective tanks, mixed by a user-controllable mixing valve (not shown) and deposited on the surface being cleaned by a selectively operable fluid deposition system. Such mixing valves and fluid deposition systems are well-known in the art. The deposited fluid may be agitated by an agitator 114, which is visible in this embodiment through a window 116 in the base 105. The agitator 114, which may comprise any kind of mechanical agitator, also is preferably selectively controlled by the operator.

In operation, the deposited fluid and any dirt or debris entrained therein is recovered from the surface being cleaned by activating the vacuum source (also selectively activated by the operator), which creates a vacuum at an extraction nozzle 118. The extraction nozzle 118 is fluidly connected to the vacuum source by way of the recovery tank 112. The fluid path between the extraction nozzle 118 and the recovery tank 112 is defined, in part, by a cavity between the base 105 and a removable nozzle cover 120. The fluid path between the recovery tank 112 and the vacuum source is defined by an enclosed passage that includes a shutoff mechanism, such as a float, that interrupts the fluid path when the liquid accumulated in the recovery tank 112 exceeds a predetermined level, to thereby prevent liquid from overflowing the recovery tank.

The wet extractor 102 also comprises a handle 122, which may be a foldable handle having a lower handle portion 124 and an upper handle portion 126. A locking mechanism 128 holds the handle portions 124, 126 rigid relative to one another. Another locking mechanism (not shown) holds the lower handle portion 124 rigid relative to the base 105 to prevent the handle 122 from moving during non-use, and is releasable, such as by a foot switch (not shown), to allow the handle 122 to pivot towards the operator during use. Such handle locking mechanisms are known in the art. The handle 122 also has a set of hand-operable controls 130 that are wired to selectively control the vacuum source, agitator 114 and fluid deposition system. Such controls are known in the art.

The wet extractor 102 is also provided with a connection system, shown covered by door 132, for attaching a remote cleaning tool. Such remote cleaning tools and other accessory tools are well-known in the art, and are useful for cleaning upholstery and other fabrics, such as curtains and even clothing. Other features, variations and details of the wet extractor 102 will be apparent to those of ordinary skill in the art.

The ultrasonic spot cleaner 104 comprises any ultrasonic wave generating source having a horn or head that can be contacted against a target surface. Examples of ultrasonic cleaning devices are provided in U.S. Pat. Nos. 4,032,803, 5,247,716, 5,309,590, 6,376,444; U.S. Application Publication No. 2001/0037537, and Japanese Publication Nos. 61-249500, 2001-113087, 2002-186921, 2002-191893, all of which are incorporated herein by reference.

The ultrasonic spot cleaner generally comprises a power supply (either a battery or a remotely-accessed outlet supply) that drives an ultrasonic frequency generator. Such frequency generators are well known, and may include a solid-state (e.g., MOSFET circuit) operated system or other feedback or feedforward control systems. The frequency generator drives a transducer (such as a langevin-type device) that, in turn, drives a horn or cleaning head to convey the ultrasonic vibrations to the target surface. The electronics are preferably stored in a water-tight hand-held case, and a protective shroud is preferably arranged around the horn to prevent unwanted contact.

The ultrasonic spot cleaner 104 may be corded or battery-operated (either disposable or rechargeable). In one embodiment, the ultrasonic spot cleaner 104 is provided with a recharging stand or plug. The ultrasonic spot cleaner 104 also may have any number of cleaning heads or cleaning head shapes (e.g., rectangular, pointed, rounded, bristled, etc.). The cleaning head also may be replaceable for cleaning different surfaces. In still other embodiments, the ultrasonic spot cleaner 104 may have multiple or variable amplitude, power and/or frequency settings to tune the device for cleaning particular surfaces. In one exemplary embodiment, the ultrasonic cleaning device operates at above 20 kHz (cycles per second), has an amplitude of about 1 to about 1000 micrometers, and operates at room temperature up to about the boiling point of the fluid (if any) desired to be used as the cleaning fluid. Any electronic control system may be used to control the ultrasonic spot cleaner. For example a feedback system and/or cutoff sensor and switch may be provided to ensure that the desired operating parameters are not exceeded.

While the ultrasonic spot cleaner 104 is described herein as being “ultrasonic” (i.e., operating above the normal range of human hearing, which typically does not exceed 20 kHz) it will be understood that the ultrasonic spot cleaner 104 may also operate well below 20 kHz and/or within the range of human hearing.

In a preferred method of use, the operator uses the wet extractor 102 to apply a cleaning fluid to a surface being cleaned, optionally agitates the fluid, and removes the fluid with the extraction nozzle 118. When the operator is unable to remove a stain or clean a particularly dirty portion of the surface, the operator applies cleaning fluid to that portion of the surface (the target area) using the wet extractor 102 and/or a separate fluid reservoir (which may be separate or stored on the wet extractor 102 or ultrasonic spot cleaner 104), removes the wet extractor 102 from the target area, activates the ultrasonic spot cleaner 104, and contacts the target area with the ultrasonic spot cleaner 104 to provide additional cleaning at that location. The ultrasonic cleaner helps remove the soil. As used herein, the term “soil” includes any type of unwanted stain, debris, dirt or other contamination, whether caused by dirt, liquids, chemicals or any other medium. The operator can use the ultrasonic spot cleaner 104 in a number of ways, such as by pressing the spot cleaner into the target area, wiping the spot cleaner across the target area, and so on. Once the operator has finished agitating the target area with the ultrasonic spot cleaner 104, the operator uses the wet extractor 102 to remove the cleaning fluid and any soil entrained therein from the target area. The operator may optionally use the wet extractor to add additional cleaning fluid and perform more agitation to the target surface before the final fluid removal step.

In order to obtain the improved cleaning performance provided by this cleaning method, in the first embodiment of the invention shown in FIG. 1, the wet extractor 102 and ultrasonic spot cleaner 104 are provided together as a kit. The kit is also preferably provided with instructions to use the ultrasonic spot cleaner 104 to spot clean particular areas during cleaning with the wet extractor 102. Such instructions preferably include the cleaning steps as described above or similar instructions.

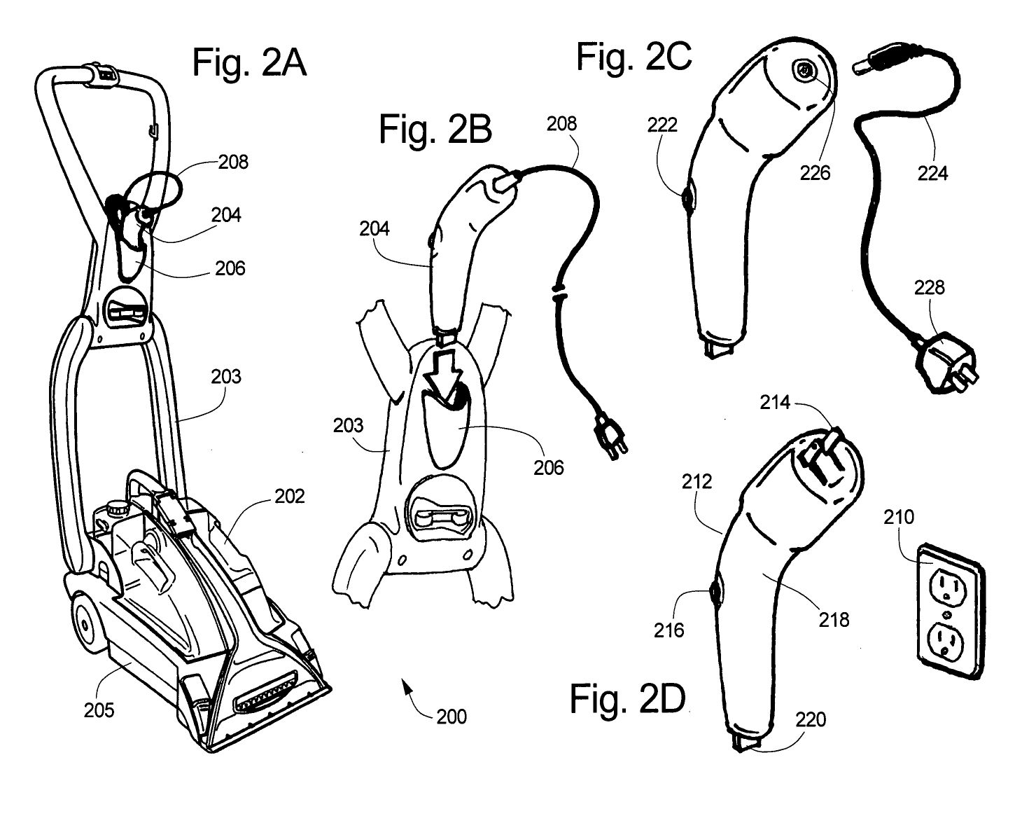

In another embodiment of the invention, shown in FIGS. 2A-D, a wet extractor 202 such as that described above or of similar construction is provided with an ultrasonic spot cleaner 204, also as described above. In this embodiment, however, the wet extractor 202 is additionally provided with a holster 206 or other enclosed or open holding chamber in which the ultrasonic spot cleaner 204 can be stored. The holster may also be replaced with any type of mounting system that allows the ultrasonic spot cleaner 204 to be stored on or in the wet extractor 202, such as a hook-and-loop (e.g. VELCRO) mount, a magnetic mount, a spring clip, or a simple hook. In embodiments in which the ultrasonic spot cleaner 204 is cord-operated, the holster 206 preferably holds the cord 208 as well, as shown in FIG. 2A. Furthermore, while the holster 206 of the embodiment of FIGS. 2A-D is shown being located in the wet extractor's handle 203, the holster may instead be located in the wet extractor's base 205.

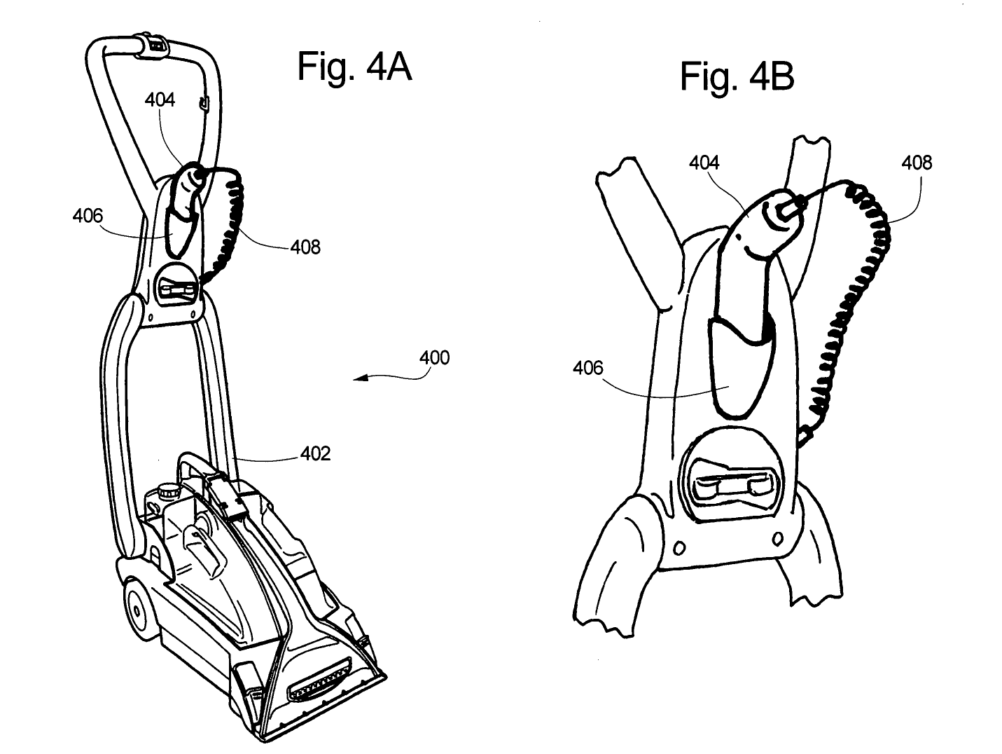

While the embodiment of FIGS. 2A-D shows the ultrasonic spot cleaner being operated by a conventional wall outlet 210 (FIG. 2D) (which may be the same outlet that powers the wet extractor 202), the corded ultrasonic spot cleaner 204 may instead be operated by being plugged into an outlet integrated into the wet extractor housing (see FIGS. 4A-B). Such an auxiliary outlet is preferably GFCI (ground fault current interrupt) protected and/or fused to protect the operator from electrocution caused by short circuits or other wiring problems.

It will also be seen that two examples of cordless ultrasonic spot cleaners are shown in FIGS. 2C and 2D. Of course, such cordless versions may be used with other embodiments of the invention. In a first cordless ultrasonic spot cleaner 212, shown in FIG. 2D, the device includes a main body 218 that contains a battery or batteries, and also houses the recharging circuitry (wiring, voltage regulators, transformers, fuses, etc.) necessary to recharge the internal battery or batteries. The device 212 is also provided with a pair of folding male electrical prongs 214 that are normally shielded by the main body 218, but fold out to fit into an outlet 210 to recharge the device. The device 212 also includes a bar-shaped cleaning head 220 and a trigger 216 to operate the device. The trigger 216 may comprise a momentary switch that only activates the device when it is being actuated by the operator, or may comprise a toggle switch that remains on after being actuated. Other controls (not shown) may be provided to modify or select the operating amplitude and/or frequency of the device.

In a second embodiment of a cordless ultrasonic spot cleaner, shown in FIG. 2C, the spot cleaner 222 comprises a separate recharging cord 224. In this embodiment, the device 222 has battery charging circuitry that is contained either the device 222 or in the recharging cord 224, or partially in both. In this embodiment, the device 222 is removably attached to the recharging cord 224 by way of a plug receptacle 226 (male or female) in the device 222. The receptacle 226 is preferably provided with a cover (not shown) for sealing the receptacle against fluid entry. A standard male wall outlet plug 228 is provided to attach the recharging cord 224 to a wall outlet 210 (FIG. 2D).

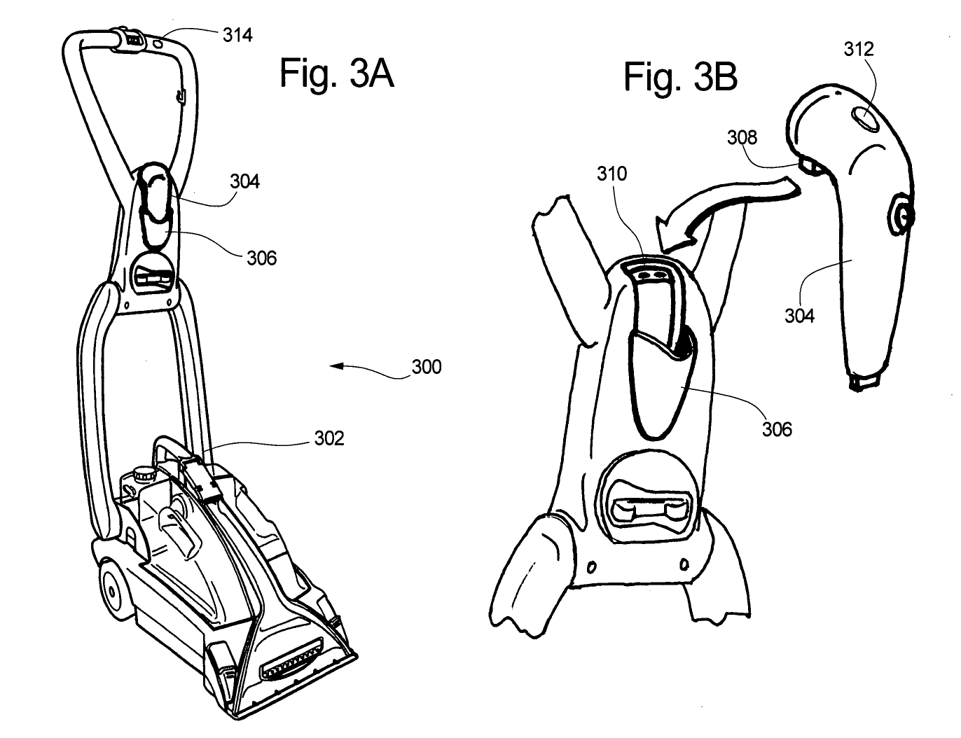

Referring now to FIGS. 3A-B, still another embodiment of the present invention is described. In this embodiment, the present invention comprises a combined cleaning device 300 having a wet extractor 302 and a rechargeable battery operated ultrasonic spot cleaner 304 that is adapted to be recharged when it is installed in a holster 306 in the wet extractor 302. As explained previously, the holster 306 may be located anywhere in the wet extractor 302, and may be exposed for direct access, or may be covered. In this embodiment, the holster 306 is provided with a charging port 310 having positive and negative charging terminals. The ultrasonic spot cleaner 304 is provided with a charging plug 308 having positive and negative terminals that fit into the charging port in a complementary manner to thereby electrically connect the device for charging. In this embodiment, the charging circuitry may be located in either the ultrasonic spot cleaner 304 or the wet extractor 302, or partially in each, and appropriate fuses and/or protection circuits (not shown) are preferably provided.

An additional feature of the embodiment of FIGS. 3A-B is the inclusion of a visual indicator 314 on the wet extractor handle or base to indicate the operating status of the ultrasonic spot cleaner 304. Such an indicator 314 may indicate various types of information, such as: whether the ultrasonic spot cleaner is being charged; whether the charge is complete; the level of charge or remaining battery life; whether any fault conditions exist (either with respect to the battery or any other feature of the spot cleaner 304 and/or wet extractor 302); and so on. The visual indicator 314 may comprise one or more lights, liquid crystal display (LCD) screens, or any other visible device that provides the user with information regarding the charging status or operational state of the ultrasonic spot cleaner 304 and/or wet extractor 302. It may also be desirable in this or other embodiments to provide such a visual indicator on the ultrasonic spot cleaner 304 itself, as shown by visual indicator 312 (either in addition to or in lieu of visual indicator 314). Such an indicator also may indicate the aforementioned information, and may also indicate when the device is on or off, which is particularly useful when the device operates outside the range of human hearing. Such a visual indicator 312 may also indicate other information relating to the operational state of the ultrasonic spot cleaner 304, such as the frequency or amplitude of the ultrasonic vibrations or the cleaning mode currently being used. The ultrasonic spot cleaner 304 also may be equipped with a tone generator (e.g., a speaker) that emits an audible tone when the device is emitting ultrasonic waves to indicate when the device is on.

In yet another embodiment, shown in FIGS. 4A-B, the invention comprises a combined cleaning device 400 having a wet extractor 402 and an ultrasonic spot cleaner 404 that is directly powered by the wet extractor 402. As with previous embodiments, a holster 406 may optionally be provided to hold the ultrasonic spot cleaner 404, and the holster may be in the wet extractor's handle or base or otherwise located on the wet extractor, and may be directly accessible or covered. However, the holster 406 is not required. In the embodiment of FIGS. 4A-B, the ultrasonic spot cleaner 404 is permanently or removably wired to the wet extractor 402 by way of an electrical cord 408. In this embodiment, the ultrasonic spot cleaner 404 also may comprise internal batteries to allow unplugged use, or may not be operable without the use of the cord 408. The cord 408 may be removably inserted into appropriate plugs in one or both of the wet extractor 402 and the ultrasonic spot cleaner 402, and may also be retractable into the wet extractor or ultrasonic spot cleaner housing to minimize the possibility of the cord 408 becoming entangled when the ultrasonic spot cleaner 404 is not in use. Any retraction device (not shown) may be used with the invention, but it is preferably spring-loaded to minimize the operator's effort to retract the cord 408. When a retractor is not used, the cord may be coiled, as shown, to minimize the cord length when not in use.

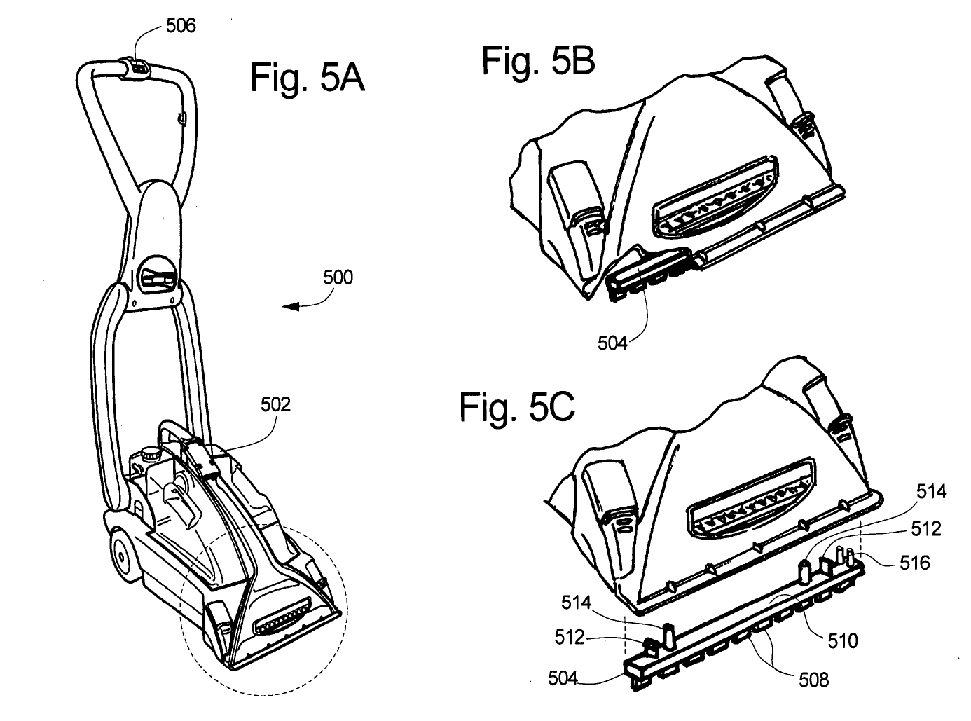

Another embodiment of the invention is shown in FIGS. 5A-C. In this embodiment, the invention comprises a combined cleaning device 500 having a wet extractor 502 and an ultrasonic spot cleaner 504 that is integrated into the wet extractor 502. The ultrasonic spot cleaner 504 may be provided in addition to, or in lieu of the wet extractor's regular agitator (if a regular agitator is provided), and may be operated by its own control circuit having a separate switch 506, or by the regular agitator's control circuit and switch.

As shown in FIGS. 5B and 5C, the ultrasonic spot cleaner 504 comprises a number of cleaning heads 508 that are attached to a common carrier bar 510. Each cleaning head 508 may have its own ultrasonic driver, or they may share common drivers. Also, a single cleaning head 508, having one or more drivers, may be used instead. Still further, the cleaning heads 508 may instead be located individually or in groups on separate carrier bars. The individual cleaning heads 508 or groups of cleaning heads may be flexibly mounted to the carrier bar 510 to allow them to move independently to a limited degree to thereby allow them to conform to uneven surfaces and provide enhanced cleaning performance. While the cleaning heads 508 of FIGS. 5B-C are shown in a generally linear pattern, other patterns may be used, such as overlapping patterns and the like. Such patterns may be tailored to clean particular surfaces, fabric types or depths of carpets, and may be adapted to clean uneven surfaces.

The ultrasonic spot cleaner 504 is retained in the wet extractor 502 such that it is contactable with the surface to be cleaned. In the shown embodiment several clips 512 and posts 514 serve to locate and retain the ultrasonic spot cleaner 504 in the proper location, in which it is suspended with the cleaning heads 508 in contact with the surface upon which the wet extractor 502 rests. The cleaning heads 508 are vertically displaceable to move up and down to follow the contours of the surface being cleaned.

While the ultrasonic spot cleaner 504 may be permanently installed in the wet extractor 502 (i.e., not intended to be removed during regular use), in the embodiment of FIGS. 5A-C, the ultrasonic spot cleaner 504 is selectively removable from the wet extractor 502. In this embodiment, the ultrasonic spot cleaner 504 may actually be installed in a cradle (not shown) that normally retains a conventional agitator (not shown), such as a bristle brush or foam scrubbing pad. Such a cradle may be adapted to vibrate or otherwise move to provide the conventional agitator with an agitating motion. When the ultrasonic spot cleaner 504 is installed, the cradle's agitating motion may be disabled or, alternatively, may be activated to give the ultrasonic spot cleaner additional mechanical agitating motion.

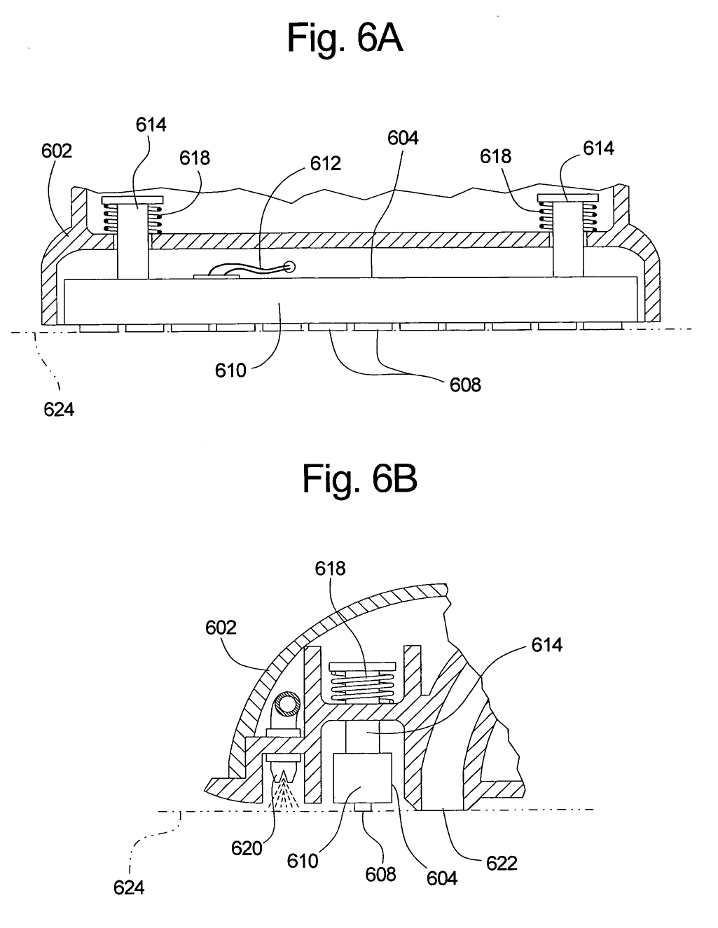

While the ultrasonic spot cleaner 504 may be battery-powered, it is preferred for the ultrasonic spot cleaner 504 to be electrically connected to the wet extractor's electrical system. In the embodiment of FIGS. 5A-C, this electrical connection is provided by plug-type electrical contacts 516 that insert into corresponding receptacles (not shown) in the wet extractor 502 to complete the electrical circuit. These electrical contacts 516 conveniently engage when the removable ultrasonic spot cleaner 504 is inserted into the wet extractor 502, and are preferably shielded to prevent contact by cleaning fluids. Alternatively, in another embodiment (see FIG. 6A), the electrical contacts 516 may be placed at the end of an electrical cord that extends from the carrier bar 510 to be inserted into a corresponding outlet located on the wet extractor 502 (or a wall outlet) away from the areas where liquid may be present, to further ensure that the electrical contacts 516 are not exposed to contact by cleaning fluids.

The embodiment of FIGS. 5A-C may be operated somewhat differently from the previous embodiments. For example, in a preferred method of use, the operator uses the wet extractor 502 to apply a cleaning fluid to a surface being cleaned, optionally agitates the fluid, and removes fluid through the extraction nozzle. When the operator is unable to remove a stain or clean a particularly dirty portion of the surface being cleaned, the operator activates the ultrasonic spot cleaner 504, and contacts the target area with the ultrasonic spot cleaner 504 to provide increased cleaning at that location. Alternatively, when no other agitator is provided, the ultrasonic spot cleaner 504 may be operated as the primary agitator to clean the entire surface being cleaned, rather than just target areas having stubborn stains. Instructions to operate the combined cleaning device 500 may optionally be provided with the device.

A number of additional features can be added to the combined cleaning device 500 to optimize cleaning performance. One additional feature is a self-propelled drive system that moves the wet extractor 502 across the surface being cleaned at a specific speed to provide optimal cleaning performance. The drive control system may have pre-selected or adjustable speed settings for various surfaces, and/or may include a feedback system that senses cleaning performance and adjusts the speed accordingly. Additional safety and convenience features also may be provided, such as control circuitry that turns off the ultrasonic spot cleaner 504 when no cleaning fluid is present, or turns off the ultrasonic spot cleaner 504 if its temperature exceeds a threshold value, if it meets excessive resistance from the surface or is pressed against the surface too hard, or if it remains in one location for more than a predetermined period of time. The fluid deposition system of the wet extractor 502 also may be adapted to have different spray nozzle positions and configurations and spray patterns to optimize the ultrasonic spot cleaner performance. In still another embodiment, the wet extractor 502 may be provided with a separate detergent deposition system, in addition to a conventional detergent deposition system, that deposits an ultrasonic-specific cleaning solution mixture during use of the ultrasonic spot cleaner 504. An additional detergent reservoir (not shown) may be provided on the wet extractor 502 as part of this embodiment.

Referring now to FIGS. 6A-B, cutaway front (FIG. 6A) and side (FIG. 6B) views of a variation of the embodiment of FIGS. 5A-C are shown. In the embodiment of FIGS. 6A-B, an ultrasonic spot cleaner 604 is retained in a wet extractor housing 602 in a permanent fashion—that is, in a manner that does not encourage or allow removing or inserting the ultrasonic spot cleaner 604 during regular use. In this embodiment, the ultrasonic spot cleaner 604 comprises a number of cleaning heads 608 that are carried by a common carrier bar 610. The ultrasonic spot cleaner 604 is powered by electrical wires 612 that are permanently or removably wired to the wet extractor's electrical system to allow selective operation thereof.

In a preferred embodiment, the ultrasonic spot cleaner 604 is retained in the wet extractor housing 602 in such a manner that it allows some vertical displacement to help the device float over the contours of the surface being cleaned 624. For example, as shown in the front cutaway view, the carrier bar 610 is held in the wet extractor housing 602 by two or more posts 614. In this embodiment, springs 618 are provided to carry a portion of the weight of the ultrasonic spot cleaner 604, and thereby reduce the amount of force applied by the ultrasonic spot cleaner 604 against the surface being cleaned 624. Of course, such springs need not be applied if the weight of the ultrasonic spot cleaner 604 is not determined or found to be too great to provide good cleaning operation. Alternatively, if the ultrasonic spot cleaner requires more downward force than its own weight can provide to give optimal cleaning, springs may be located between the carrier bar 610 and the wet extractor housing 602 to bias the ultrasonic spot cleaner 604 downward into the surface being cleaned 624. In either case, the springs may be placed on moveable perches (not shown) to adjust their preload to increase or decrease the force applied to the surface being cleaned 624. It is also envisioned that the ultrasonic spot cleaner 604 can be mounted such that it can be lifted entirely from the surface being cleaned 624 to prevent its use.

FIG. 6B also shows one possible location of the ultrasonic spot cleaner 604 relative to other wet extractor components. (The front of the wet extractor is to the left in this view.) In this embodiment, the ultrasonic spot cleaner 604 is located between the spray nozzle(s) 620 and the extraction nozzle(s) 622. As the device is moved forward (i.e., to the left in FIG. 6B), cleaning fluid is deposited on the surface being cleaned 624, agitated by the ultrasonic spot cleaner 604, then recovered by the extraction nozzle 622. Other configurations, such a reversed configuration or a configuration having spray nozzles or extraction nozzles located on both sides of the ultrasonic spot cleaner (or multiple ultrasonic spot cleaners) may also be used.

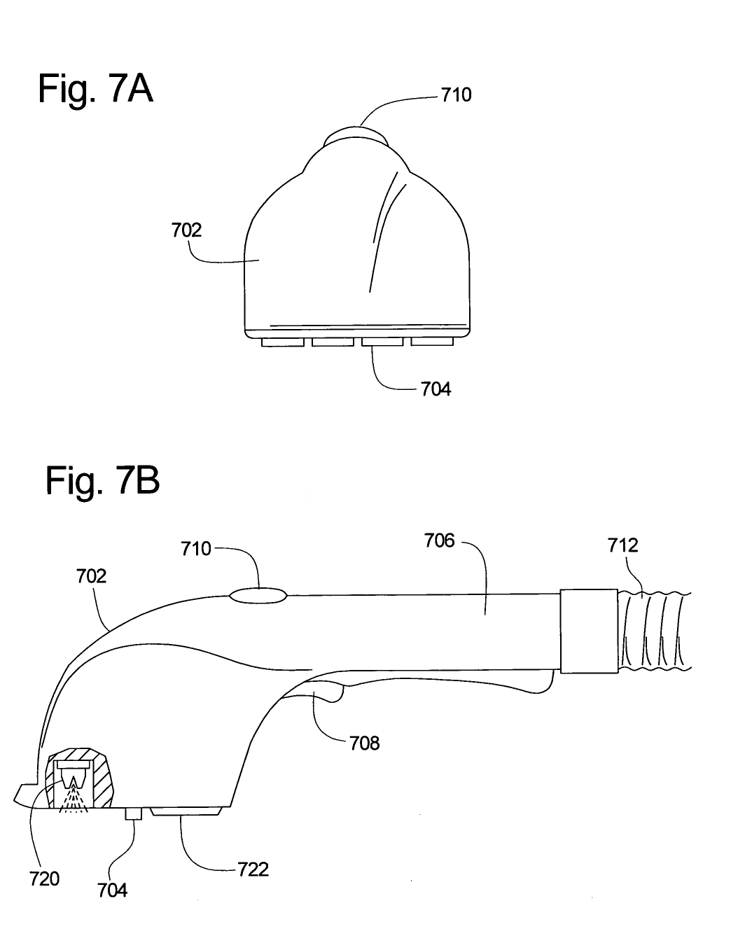

In still another embodiment of the invention, shown in FIGS. 7A-B, an ultrasonic spot cleaner 704 may be permanently or removably integrated into a wet extractor remote accessory tool 702. In this embodiment, the accessory tool is provided with an ultrasonic spot cleaner 704, a cleaning fluid spray nozzle 720, and an extraction nozzle 722. A grip 706 is provided for the operator to grasp, and a trigger 708 is provided for activating the spray nozzle 720 to deposit fluid. A switch 710 is provided to activate the ultrasonic spot cleaner 702.

The accessory tool 702 is attached to a wet extractor (not shown) by way of a flexible hose 712, which houses electrical wires to supply power to the ultrasonic spot cleaner 704, a fluid hose to provide fluid to the nozzle 720, and a vacuum passage that leads to the extraction nozzle 722. Alternatively, the ultrasonic spot cleaner 704 may be provided as a removable unit, as described with reference to FIGS. 5A-C, that is powered by the wet extractor electrical system, by separate attachment to a power outlet, or by batteries. The use of a battery-powered ultrasonic spot cleaner in the accessory tool 702 is particularly desirable if there is concern that running electrical wires to power the ultrasonic spot cleaner 704 through or along the hose 812 might result in an electrocution hazard. Naturally, the other variations described above with reference to FIGS. 5A-C and elsewhere herein may be employed with the embodiments of FIGS. 6A-B and 7A-B.

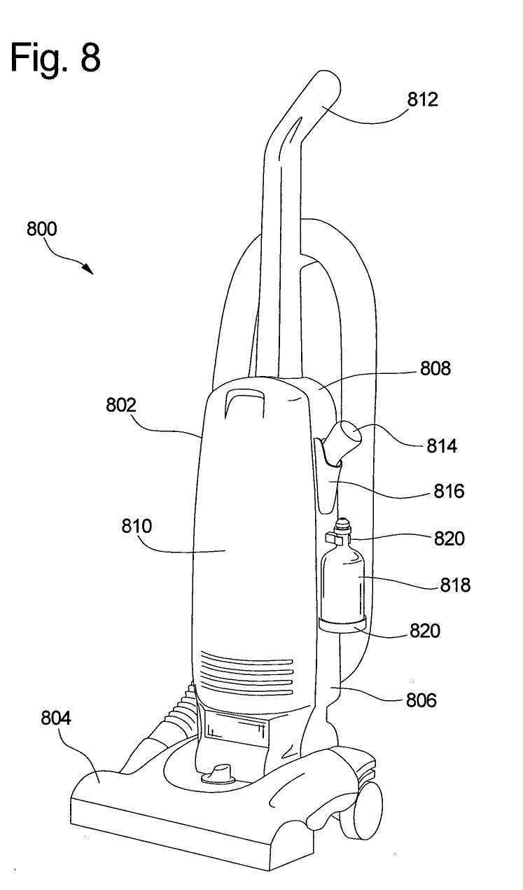

As explained previously herein, the wet extractor of the invention can be replaced by a vacuum. Such a vacuum can be any type of vacuum, such as a bag vacuum, a bagless vacuum, a cyclonic vacuum, and the like. FIG. 8 shows another embodiment of a combined cleaning system 800 of the invention in which the wet extractor has been replaced by a conventional bag vacuum 802. The vacuum 802 is of the upright variety having a base 804 adapted to move on a surface being cleaned and a rear housing 806 pivotally attached to the base 804. The rear housing 806 has a covered vacuum bag storage compartment 810 (or dirt cup, which may surround or be below a cyclonic separator), and an operating handle 812. In this embodiment, an ultrasonic spot cleaner 814 is provided to fit into a holster 816 on the side of the rear housing 806.

The combined cleaning system 800 also may have a separate fluid reservoir 818 stored thereon, as described above with reference to the embodiment of FIG. 1. Clips 820 or other mounting devices are provided to securely hold the fluid reservoir 818, which in this case is a simple spray bottle as are known in the art. The fluid reservoir 818 is provided to contain a cleaning fluid for use with the ultrasonic spot cleaner 814, if desired. It will also be appreciated that the ultrasonic spot cleaner 814 may alternatively be provided with its own fluid reservoir, as also noted above with respect to the embodiment of FIG. 1. It will also be appreciated that the ultrasonic spot cleaner 814 and/or fluid reservoir 818 may be located elsewhere on the vacuum cleaner 802.

While the foregoing embodiments have described a combined cleaning device having a upright wet extractor or vacuum cleaner and an ultrasonic spot cleaner, in other embodiments the combined cleaning device may instead comprise a steam cleaner, or other type of cleaner used in conjunction with an ultrasonic spot cleaner. It will also be understood that the present invention is also applicable for use with non-upright (e.g., portable or canister) cleaners. It will also be understood that many other variations can be used with the present invention, for example, the ultrasonic spot cleaner may be mounted on a handle that allows it to be used to clean stubborn spots on a floor without requiring the user to bend over. Moreover, it will be understood that any permutations of the invention that are described herein with reference one embodiment of the invention may also be practiced with other embodiments.

1. A method for cleaning a surface, the method comprising:
depositing a cleaning fluid onto the surface from a cleaning fluid reservoir on a wet extractor;
contacting the surface with a hand-held ultrasonic spot cleaner;
applying ultrasonic vibrations to the surface using the hand-held ultrasonic spot cleaner to help release soil from the surface; and
removing the cleaning fluid and soil from the surface using the wet extractor.

2. The method of claim 1, further comprising:
agitating the surface with a mechanical agitator on the wet extractor.

3. The method of claim 1, further comprising:
depositing a rinsing fluid onto the surface from a rinsing fluid reservoir on the wet extractor; and
removing the rinsing fluid from the surface using the wet extractor.

4. The method of claim 1, further comprising depositing a second fluid onto the surface from a second fluid reservoir separate from the wet extractor and the hand-held ultrasonic spot cleaner.

5. The method of claim 1, further comprising depositing a second fluid onto the surface from a second fluid reservoir on the hand-held ultrasonic spot cleaner.

6. An ultrasonic wet extractor comprising:
a base assembly adapted to be moved on a surface to be cleaned;
a handle assembly pivotally connected to the base assembly and adapted to be used to direct the movement of the base assembly;
one or more fluid supply tanks;
a fluid deposition system adapted to deposit at least a first fluid from the one or more fluid supply tanks onto the surface;
a fluid recovery tank;
an extraction nozzle mounted on the base assembly and positioned to face the surface;
a vacuum source adapted to create a working air flow from the extraction nozzle to the fluid recovery tank; and
an ultrasonic vibration device, mounted in the base assembly adjacent the surface and adapted to impart ultrasonic vibrations to the surface.

7. The ultrasonic wet extractor of claim 6, wherein at least one of the one or more fluid supply tanks is mounted on the base assembly.

8. The ultrasonic wet extractor of claim 6, wherein the one or more fluid supply tanks comprise a water supply tank and a detergent tank.

9. The ultrasonic wet extractor of claim 6, wherein the recovery tank is mounted on the base assembly.

10. The ultrasonic wet extractor of claim 6, wherein the ultrasonic vibration device comprises:
a laterally-extending carrier bar;
a plurality of cleaning heads mounted to the carrier bar; and
one or more ultrasonic drivers adapted to impart ultrasonic vibrations in the plurality of cleaning heads.

11. The ultrasonic wet extractor of claim 6, wherein the ultrasonic vibration device is movable, relative to the base assembly, in a direction perpendicular to the surface.

12. A combined cleaning system comprising:
a cleaning device comprising:
a dirt receptacle;
a nozzle adapted to be positioned adjacent a surface to be cleaned;
a vacuum source adapted to generate a working air flow from the nozzle to the dirt receptacle; and
a hand-held ultrasonic spot cleaner comprising:
an ultrasonic wave generating source;
an ultrasonic cleaning head adapted to be driven by the ultrasonic wave generating source; and
a control switch adapted to selectively activate the ultrasonic wave generating source.

13. The combined cleaning system of claim 12, further comprising a mount to hold the hand-held ultrasonic spot cleaner on the cleaning device.

14. The combined cleaning system of claim 13, wherein the mount comprises a holster on the cleaning device adapted to receive the hand-held ultrasonic spot cleaner.

15. The combined cleaning system of claim 12, wherein the cleaning device further comprises an electrical circuit adapted to provide electricity to the hand-held ultrasonic spot cleaner.

16. The combined cleaning system of claim 15, wherein the electrical circuit comprises a flexible electrical cord connecting the cleaning device to the hand-held ultrasonic spot cleaner.

17. The combined cleaning system of claim 16, wherein the cleaning device further comprises a cordreel adapted to selectively retract the flexible electrical cord into the cleaning device housing.

18. The combined cleaning system of claim 16, wherein the flexible electrical cord is selectively disconnectable from at least one of the cleaning device and the hand-held ultrasonic spot cleaner.

19. The combined cleaning system of claim 15, wherein the cleaning device comprises a holster adapted to receive the hand-held ultrasonic spot cleaner, and the electrical circuit comprises an electrical terminal adapted to engage a corresponding electrical terminal on the hand-held ultrasonic spot cleaner when the hand-held ultrasonic spot cleaner is inserted into the holster.

20. The combined cleaning system of claim 19, wherein the hand-held ultrasonic spot cleaner further comprises rechargeable batteries.

21. The combined cleaning system of claim 12, wherein the hand-held ultrasonic spot cleaner further comprises an electrical cord and is adapted to be powered by a wall outlet.

22. The combined cleaning system of claim 12, wherein the hand-held ultrasonic spot cleaner further comprises one or more batteries.

23. The combined cleaning system of claim 22, wherein the one or more batteries are rechargeable, and the hand-held ultrasonic spot cleaner further comprises a battery charging circuit.

24. The combined cleaning system of claim 23, wherein the battery charging circuit comprises an electrical circuit selectively attachable to a corresponding electrical circuit in the cleaning device.

25. The combined cleaning system of claim 24, wherein the battery charging circuit further comprises a visual indicator that indicates the operating status one or more features of the combined cleaning system.

26. The combined cleaning system of claim 25, wherein the visual indicator indicates the charging status of the hand-held ultrasonic spot cleaner.

27. The combined cleaning system of claim 23, wherein the battery charging circuit comprises an electrical cord adapted to engage a wall outlet, the electrical cord being selectively detachable from the hand-held ultrasonic spot cleaner.

28. The combined cleaning system of claim 23, wherein the battery charging circuit comprises electrical prongs located on the hand-held ultrasonic spot cleaner, the electrical prongs being adapted to selectively engage a wall outlet.

29. The combined cleaning system of claim 28, wherein the electrical prongs are selectively retractable into the hand-held ultrasonic spot cleaner.

30. The combined cleaning system of claim 12, wherein the hand-held ultrasonic spot cleaner further comprises an audible signal generator adapted to create a human-audible sound when the ultrasonic wave generating source is activated.

31. The combined cleaning system of claim 12, wherein the hand-held ultrasonic spot cleaner further comprises a fluid supply reservoir mounted thereto.

32. The combined cleaning system of claim 12, further comprising a fluid supply reservoir adapted to be stored on the cleaning device.

33. The combined cleaning system of claim 12, wherein the cleaning device further comprises:
a base assembly adapted to be moved on a surface to be cleaned;
a handle assembly pivotally connected to the base assembly and adapted to be used to direct the movement of the base assembly.

34. The combined cleaning system of claim 12, wherein the cleaning device is a wet extractor, and further comprises:
one or more fluid supply tanks;
a fluid deposition system adapted to deposit at least a first fluid from the one or more fluid supply tanks onto a surface to be cleaned; and
wherein the dirt receptacle comprises a recovery tank and the nozzle comprises an extraction nozzle.

35. The combined cleaning system of claim 12, wherein the cleaning device is a vacuum cleaner, and wherein the dirt receptacle is a vacuum bag or a dirt cup.

36. A combined cleaning system comprising:
a wet extractor comprising:
one or more fluid supply tanks;
a fluid deposition system adapted to deposit at least a first fluid from the one or more fluid supply tanks onto a surface to be cleaned;
a recovery tank;
an extraction nozzle adapted to be positioned adjacent the surface to be cleaned;
a vacuum source adapted to generate a working air flow from the extraction nozzle to the recovery tank; and
a hand-held ultrasonic spot cleaner adapted to be selectively mounted on the wet extractor, the hand-held ultrasonic spot cleaner comprising:
an ultrasonic wave generating source;
an ultrasonic cleaning head adapted to be driven by the ultrasonic wave generating source; and
a control switch adapted to selectively activate the ultrasonic wave generating source.

37. The combined cleaning system of claim 36, wherein the hand-held ultrasonic spot cleaner is selectively electrically attachable to the wet extractor.

38. A combined cleaning system comprising:
a vacuum cleaner comprising:
a dirt container;
a nozzle adapted to be positioned adjacent the surface to be cleaned;
a vacuum source adapted to generate a working air flow from the nozzle to the dirt container; and
a hand-held ultrasonic spot cleaner adapted to be selectively mounted on the vacuum cleaner, the hand-held ultrasonic spot cleaner comprising:
an ultrasonic wave generating source;
an ultrasonic cleaning head adapted to be driven by the ultrasonic wave generating source; and
a control switch adapted to selectively activate the ultrasonic wave generating source.

39. The combined cleaning system of claim 38, wherein the hand-held ultrasonic spot cleaner is selectively electrically attachable to the vacuum cleaner.
